(19) United States
(12) Patent Application Publication
(10) Pub. No.: US 2012/0328288 A1
(43) Pub. Date: Dec. 27, 2012

(54) METHOD FOR AGGREGATING MULTIPLE CLIENT SIGNALS INTO A GENERIC FRAMING PROCEDURE (GFP) PATH

(75) Inventors: MICHAEL ANDREW VANDEGRIEND, Ottawa (CA); ILIAN SEVDALINOV TZVETANOV, Ottawa (CA)

(73) Assignee: EXAR CORPORATION, Fremont, CA (US)

(21) Appl. No.: 13/167,584

(22) Filed: Jun. 23, 2011

(51) Int. Cl. H04J 14/00

(52) U.S. Cl. 398/43

(57) ABSTRACT

Used bandwidth counts for each of multiple client streams are maintained. A used bandwidth count for a client stream is increased when data from the client stream is put in a Generic Framing Procedure (GFP) frame onto the GFP path and is decreased once every time period by allocated bandwidth credits value. The used bandwidth count for a client stream is compared with a bandwidth limit before sending data in the client stream in a GFP frame onto the GFP path.

### FIELD OF THE INVENTION

The present application relates to methods of aggregating multiple client streams into an optical networking protocol, such as the Generic Framing Procedure.

### BACKGROUND

Optical networking is a way to send large amounts of data across optical fiber. A number of protocols have been developed to transmit the optical signals.

As demand for high speed data becomes more desirable, optical switched networks, such as the optical transport network (OTN) and synchronous optical networking (SONET)/synchronous digital hierarchy (SDH), have become more popular.

One way to send client signals over a transport network is to use the Generic Framing Procedure (GFP).

Generic Framing Procedure (GFP) is a mapping technique defined by ITU-T G.7041. It allows mapping of variable length, higher-layer client signals over a circuit switched transport network like OTN or SDH/SONET.

There are two types of GFP frames: a GFP client frame and a GFP control frame. A GFP client frame can be further classified as either a client data frame or a client management frame. The former is used to transport client data, while the latter is used to transport point-to-point management information like loss of signal, etc. Client management frames can be differentiated from the client data frames based on the payload type indicator. The GFP control frame currently consists only of a core header field with no payload area. This frame is used to compensate for the gaps between the client signal where the transport medium has a higher capacity than the client signal, and is better known as an idle frame.

Different GFP frames can transmit data from different client input streams. A channel ID field allowing for 256 channels is used to identify the client input stream.

There are two modes of GFP: Generic Framing Procedure—Framed (GFP-F) and Generic Framing Procedure—Transparent (GFP-T):
GFP-F maps each client frame into a single GFP frame. GFP-F is used where the client signal is framed or packetized by the client protocol.
GFP-T, on the other hand, allows mapping of 8B/10B block-coded client data into an efficient 64B/65B block code for transport within a GFP frame.

### SUMMARY

Embodiments of the present invention concern methods for aggregating client streams onto a GFP path.

It is important that the method for aggregating the client data stream provides low latency and sufficient bandwidth to the client streams so that the client streams are not overly delayed or some of the client streams ignored.

In one embodiment, each of the client streams is given an allocation of bandwidth credit for a time period. The bandwidth credits roughly correspond to the amount of data from the client stream to be transmitted in GFP frames in a GFP path for the time period. Used bandwidth counts are maintained for each of the client streams. The used bandwidth count for a client stream is increased when data from the client stream is put in a GFP frame and transmitted and is decreased once every time period by the allocated bandwidth count for a client stream. The used bandwidth count is compared with a bandwidth limit before sending data in the client stream in a GFP frame onto the GFP path.

The system cycles through a list of the client streams. If the current client stream has a GFP frame worth of data to send and the used bandwidth count for the current client is below the bandwidth limit, the system will put the client's stream's data into a GFP frame and send it on the GFP path. The used bandwidth count for the client stream is then increased by an amount corresponding to the amount of data sent in the GFP frame. After the time period expires, a new allocation of bandwidth credits is done.

The allocation of bandwidth credits ensures that the latency is kept low and each client stream has sufficient bandwidth.

### BRIEF DESCRIPTION OF THE DRAWINGS

FIG. 1 shows a diagram of the selection of client streams for the next GFP frame of a GFP path.

FIG. 2 shows a scheduling algorithm using the allocation of bandwidth credits for client streams in a time period.

### DETAILED DESCRIPTION OF THE EMBODIMENT

The Generic Framing Procedure (GFP) is a standard communication protocol that specifies a mechanism for adapting traffic from client signals for transmission through a transport network. GFP can be used for optical networks, wired electrical networks or wireless networks. A GFP adaptation mechanism is assigned to a transport network path (for example, an optical transport network (OTN) payload) and may adapt traffic into this path from one or multiple clients. The GFP adaptation process uses a frame structure that includes multiple header fields and a client payload area.

In the case of aggregating multiple clients onto a transport path, the GFP standard specifies an extension header for a linear (point-to-point) frame. This extension header contains a channel ID field that identifies the communication channel associated with the frame and allows for up to 256 channels. The aggregated client signals may have different rates and latency and bandwidth requirements.

In order to manage the latency and bandwidth requirements of each client signal being aggregated, a scheduling algorithm is implemented. Without such an algorithm, a client signal may not be allocated enough bandwidth which can lead to consistent data loss from the client. Alternately, a client signal may be allocated enough bandwidth, but too infrequently which can lead to periodic data loss. Thus, the scheduling algorithm must be able to control the overall allocation of bandwidth and the frequency of bandwidth allocation.

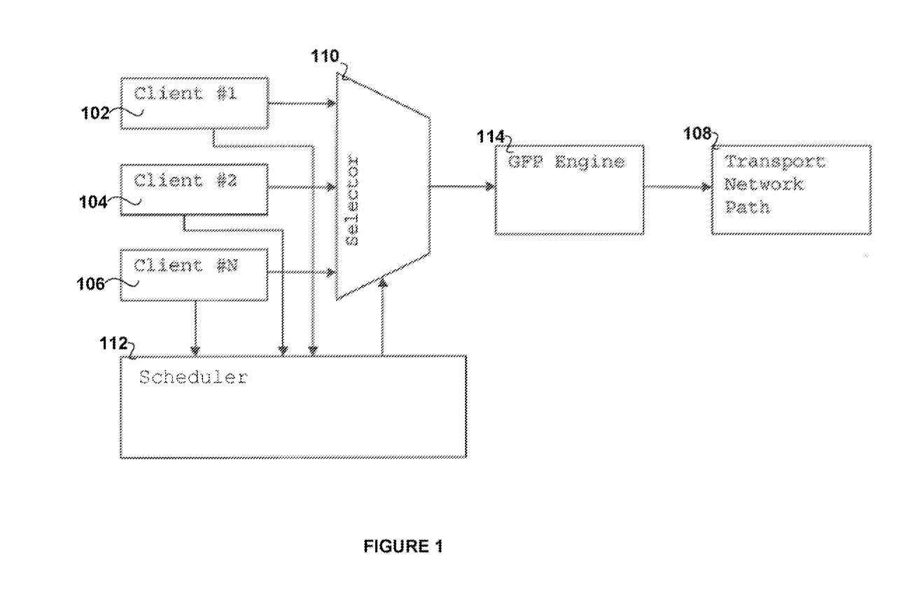

FIG. 1 shows an exemplary aggregator of client stream data. Client streams 102, 104 and 106 are received for a GFP path 108.

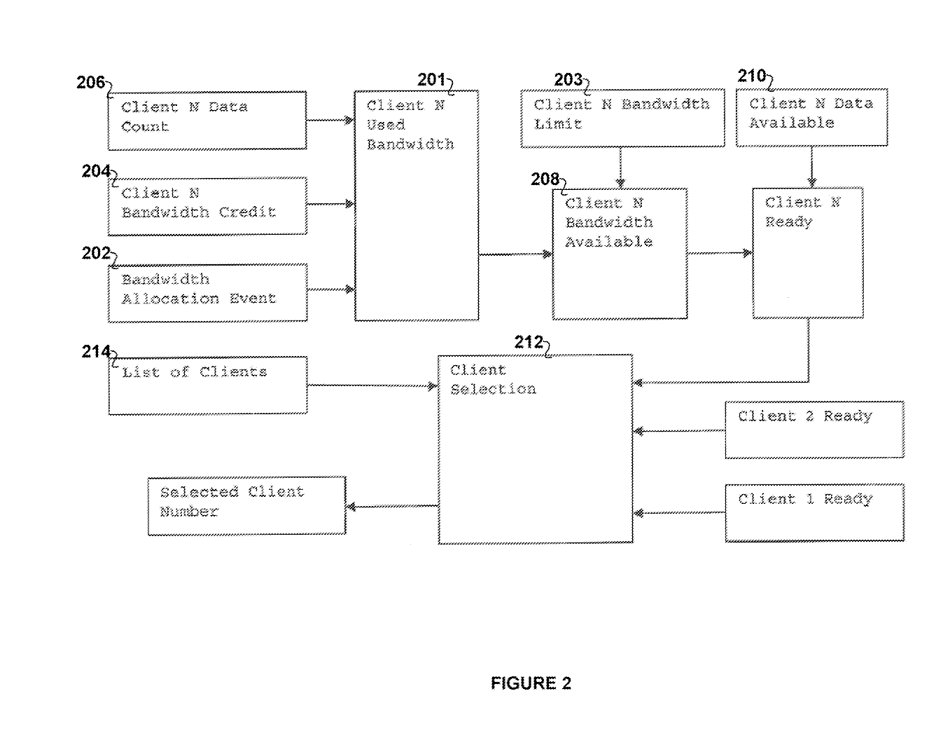

The selector 110 selects data from the client stream 102, 104 or 106 according to the scheduler 112 shown in detail in FIG. 2. GFP engine 114 puts the data from the selected client stream into a GFP frame to send on the GFP path 108.

A list of client signals assigned to the GFP path is maintained. From this list of client signals, the GFP engine will select one client to send data over the transport network path at any given time. After one GFP frame of data has been sent, the GFP engine will either select a new client to send data from or continue sending data from the current client.

The scheduling algorithm determines which client to serve next based on which clients have data available to send and have available bandwidth in their allocation. The list of client signals provides the order in which the scheduling algorithm searches for next client signal to serve.

FIG. 2 shows an exemplary scheduler of one embodiment.

The available bandwidth algorithm operates as follows. Each client maintains a count of the amount of data it has transmitted over the GFP path, known as the used bandwidth count 201. A time period, corresponding to the bandwidth allocation event 202, is specified that determines how often more bandwidth is allocated to each client. The amount of bandwidth allocation 204, or credit, can be different for each client and is subtracted from the used bandwidth count 201. For each client, there is a bandwidth limit 203. If the used bandwidth count 201 exceeds the bandwidth limit, then there is no more bandwidth available for that client until the next bandwidth credit event. When the used bandwidth exceeds the limit, the scheduling algorithm stops servicing that client until the used bandwidth falls below the limit.

Block 204 indicates the allocation amount of bandwidth credit for client N. Block 206 indicates the amount of data sent in a GFP frame for client N. These values increment the used bandwidth count in block 201. If the used bandwidth count in block 201 is below the client bandwidth limit in block 203, block 208 will indicate that the bandwidth is available for client N. If client N has a GFP frame worth of data available, as shown by block 210, and has sufficient bandwidth as shown by block 208, the client selection block 212 indicates that client N is ready.

A client list 214 is cycled through selecting the ready clients in order. After the time period, a new client stream bandwidth allocation is done.

The foregoing description of preferred embodiments of the present invention has been provided for the purposes of illustration and description. It is not intended to be exhaustive or to limit the invention to the precise forms disclosed. Many embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

1. A method for aggregating client streams onto a generic framing procedure (GFP) path comprising:
receiving client streams of data for a GFP path;
maintaining used bandwidth counts for each of the client streams, a used bandwidth count for a client stream being increased when data from the client stream is put in a GFP frame onto the GFP path;
decreasing the used bandwidth count once every time period by an allocated bandwidth credit value; and
comparing the used bandwidth count for a client stream with a bandwidth limit before sending data in the client stream in a GFP frame onto the GFP path.

2. The method of claim 1, wherein a list of clients are maintained.

3. The method of claim 2, wherein the list is cycled through to determine what client stream is to have data sent in the GFP path.

4. The method of claim 3, wherein if a current client has sufficient queued data for a GFP frame and the used bandwidth count for the current client is below the bandwidth limit, the queued data is sent in a GFP frame along the GFP path.

5. The method of claim 1, wherein the allocated bandwidth credits provide sufficient bandwidth for the client streams.

6. The method of claim 1, wherein the time period is such that the latency caused by the placing of the data onto the GFP frames is kept below a predetermined value.

7. The method of claim 1, wherein different client streams have different allocated bandwidth credit values.

8. The method of claim 1, wherein a channel ID of the GFP frame identifies the client stream for the GFP frame.

9. The method of claim 1, wherein different client streams have different bandwidth limits.

10. An apparatus adapted to:
receive client streams of data for a GFP path;
maintain used bandwidth counts for each of the client streams, a used bandwidth count for a client stream being increased when data from the client stream is put in a GFP frame onto the GFP path;
decrease the used bandwidth count once every time period by an allocated bandwidth credit value; and
comparing the used bandwidth count for a client stream with a bandwidth limit before sending data in the client stream in a GFP frame onto the GFP path.

11. The apparatus of claim 10, wherein a list of clients are maintained.

12. The apparatus of claim 11, wherein the list is cycled through to determine what client stream is to have data sent in the GFP path.

13. The apparatus of claim 12, wherein if a current client has sufficient queued data for a GFP frame, and the used bandwidth count for the current client is below the bandwidth limit, the queued data is sent in a GFP frame along the GFP path.

14. The apparatus of claim 10, wherein the allocated bandwidth credits provide sufficient bandwidth for the client streams.

15. The apparatus of claim 10, wherein the time period is such that the latency caused by the placing of the data onto the GFP frames is kept below a predetermined value.

16. The apparatus of claim 10, wherein different client streams have different allocated bandwidth credit values.

17. The apparatus of claim 10, wherein a channel ID of the GFP frame identifies the client stream.

18. The apparatus of claim 10, wherein different client streams have different bandwidth limits.
